(19) United States
(12) Patent Application Publication
(10) Pub. No.: US 2002/0050413 A1
(43) Pub. Date: May 2, 2002

(54) Engine undertray for a vehicle with improved strength

(76) Inventor: Thierry Renault, Vernon (FR)

Correspondence Address: David R. Syrowik, Brooks & Kushman P.C., 1000 Town Center, 22nd Floor, Southfield, MI, 48075-1351, US

(21) Appl. No.: 09/960,436

(22) Filed: Sep. 21, 2001

(30) Foreign Application Priority Data
Sep. 22, 2000 (FR) 00 12077

(51) Int. Cl. B62D 25/20

(52) U.S. Cl. 180/69.1

(57) ABSTRACT

The engine undertray (12) for a vehicle comprises an essentially flat part (14) and at least one section piece (16, 18), one out of the flat part and the section piece comprising a first material with two layers of reinforced thermoplastic between which an intermediate layer extends, the other out of the flat part and the section piece comprising a second material different than the first material. The intermediate layer is a layer of cellular material.

The invention relates to engine undertrays for motor vehicles.

At the present time, components that close the body off under the engine, commonly known as engine undertrays, which exist on many motor vehicles, are simple sheets made of pressable reinforced thermoplastic, SMC or injection-molded polypropylene, fixed to the bottom end of the bumpers and under the engine resting against the engine mounting.

Such closure components, as their name suggests, are intended to close off the lower part of the engine mounting to isolate the engine from the outside and thus protect it from any impact resulting, for example, from curbing, and from splashes of water and mud as the vehicle travels along. A closure component such as this also makes it possible to prevent oil from the engine from running out onto the ground.

It has recently been envisioned for such a closure component under an engine to be used to absorb some of the kinetic energy in the event of the vehicle being involved in frontal, oblique or side impact.

Application EP-0 847 912 presents an engine undertray with a flat part comprising two layers consisting of a balanced weave of strands comprising glass fibers embedded in polypropylene, and a central layer of a reinforced thermoplastic sandwiched between the previous two. The undertray also carries two auxiliary longitudinal members.

This component has the drawback of using a material that is employed at high pressure (250×10⁵ Pa) in a 2500-metric tonne press for an area of 1 m² and of having a mean density of 1.2, namely a weight per m² of 3 kg/m² for a thickness of 2.5 mm.

This component is therefore expensive to manufacture and relatively heavy once produced. In addition, its rigidity may prove insufficient. Now, good rigidity is desirable in order to limit the number of fixings to fix the component to the vehicle and to give the undertray better stability in a crash at 56 or 65 km/h.

One object of the invention is to provide an undertray which is less heavy and more rigid, and preferably more economical to manufacture.

With a view to achieving this objective, the invention envisions an engine undertray for a vehicle, comprising an essentially flat part and at least one section piece, one out of the flat part and the section piece comprising a first material with two layers of reinforced thermoplastic between which an intermediate layer extends, the other out of the flat part and the section piece comprising a second material different than the first material, in which the intermediate layer is a layer of cellular material.

Thus, it is possible without difficulty to obtain an undertray 5 mm thick with a weight of 1600 to 1700 g/m². In addition, this undertray can be obtained by means of low-pressure process employing, for example, a 200-metric tonne (rather than a 2500-metric tonne) press. Finally, the rigidity of this new undertray is higher. It has, for example, a flexural rigidity of 1 N.m² for a thickness of 5 mm as opposed to 0.4 N.m² for an undertray of the prior art 2.5 mm thick.

The undertray according to the invention may furthermore have at least one of the following features:

the material comprises at least one layer of thermoplastic;

the flat part comprises the first material;

the section piece comprises the first material;

the cellular material has a honeycomb structure;

in the flat part, at least one of the layers of thermoplastic comprises thermoplastic fibers and glass fibers;

the thermoplastic fibers and the glass fibers are woven;

the section piece runs transversely with reference to a direction of the component that is intended to correspond to the direction of travel of the vehicle;

it comprises at least two section pieces running parallel to a direction of the component that is intended to correspond to the direction of travel of the vehicle;

the or each section piece comprises a stack of two pairs of layers of thermoplastic and two layers of cellular material, one extending between the layers of each respective pair, and

the flat part has corrugations.

Other features and advantages of the invention will become further apparent in the following description of a preferred embodiment which is given by way of nonlimiting example. In the appended drawings:

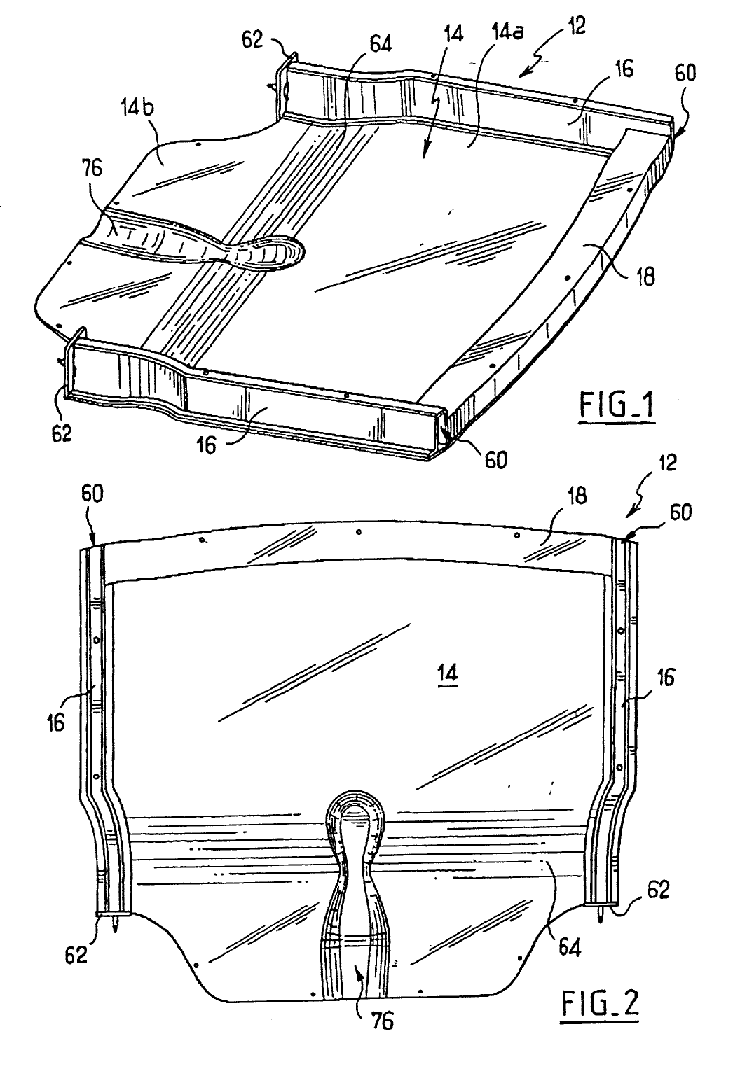

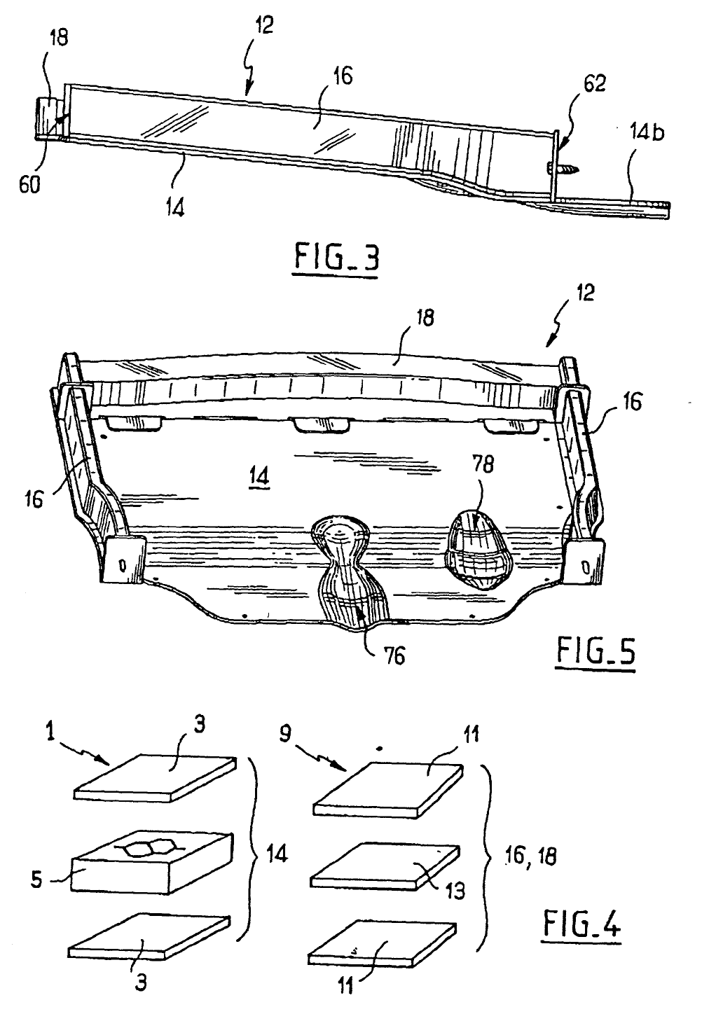

FIGS. 1, 2 and 3 are three views, in perspective, from above and from the side, of an undertray according to a preferred embodiment of the invention;

FIG. 4 is a schematic view of the stacks that make up the materials of the undertray of FIG. 1;

FIG. 5 is a perspective view illustrating an alternative form of this undertray;

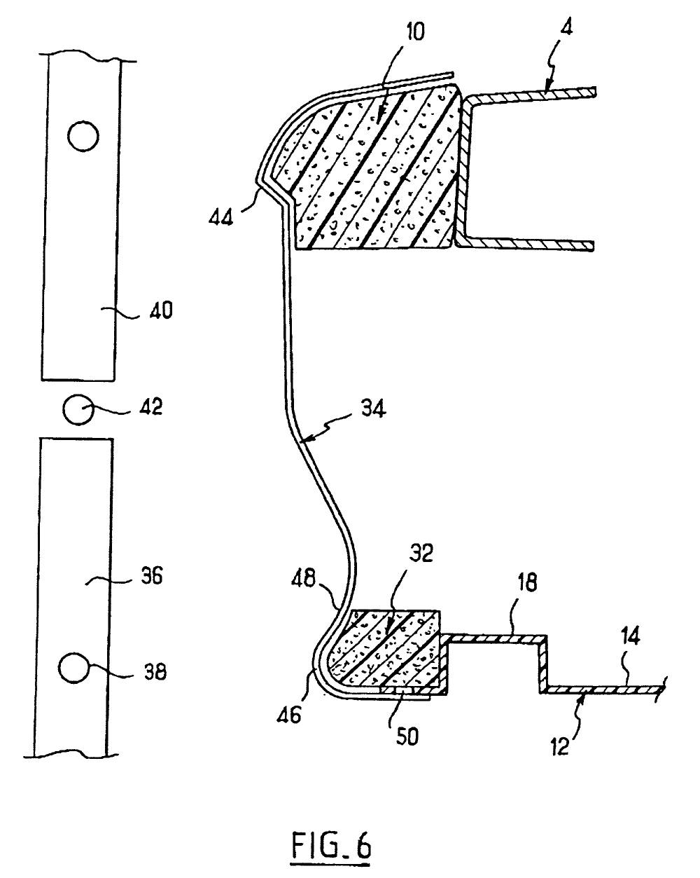

FIG. 6 is a view in cross section of the mounting of an undertray according to a second embodiment in a vehicle, the figure also schematically illustrating the leg of a pedestrian; and

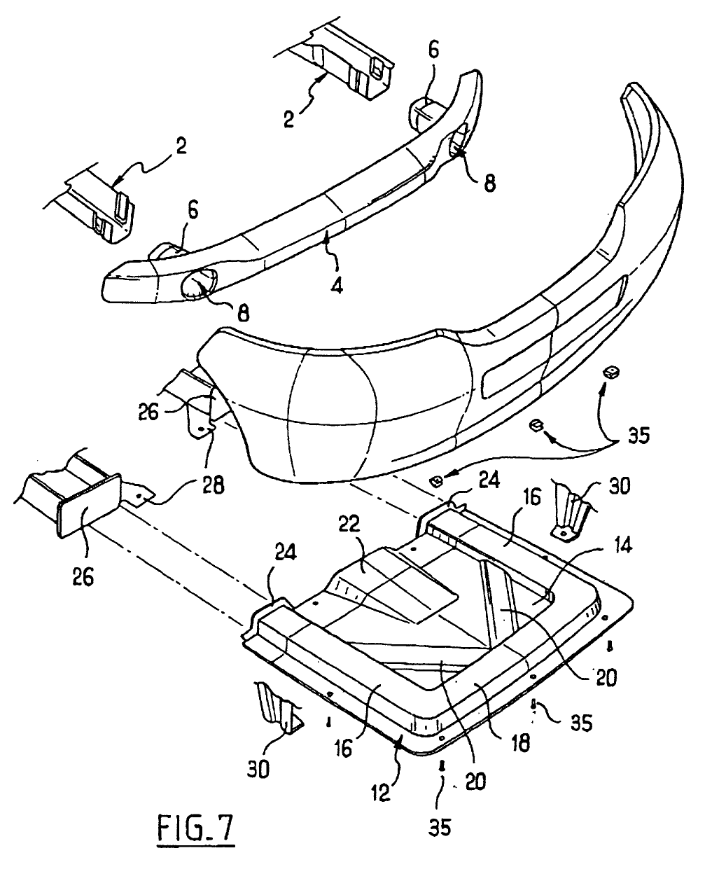

FIG. 7 is an exploded perspective view of the bodywork of the vehicle of FIG. 6, without the impact absorbers.

FIGS. 1 to 4 illustrate a first embodiment of the undertray according to the invention.

The undertray 12 comprises a wall 14 of rectangular overall shape and not strictly flat, and two profiled longitudinal members or auxiliary longitudinal members 16 running in the direction corresponding to the direction of travel of the vehicle, near to the respective lateral edges of the wall. The undertray 12 further comprises a front transverse section piece 18 in the form of a beam running close to a front edge of the wall 14. In plan view, the section piece 18 forms, with the longitudinal members 16, a “U” which is open toward the rear. The two longitudinal members 16 and the section piece 18 in this instance are contiguous. They are attached to the top surface of the wall 14.

The longitudinal members 16 and the beam 18 in cross section have the profile of a “U” open downward. The opening of this profile is closed off by the wall. The three section pieces are hollow.

The auxiliary longitudinal members 16 have an open front end 60 and a rear end 62 which is closed off by a wall. The auxiliary longitudinal members 16 have rear end portions which are closer together than the other parts of the auxiliary longitudinal members.

The beam 18 has a shape which is slightly bowed into a circular arc in the plane of the undertray, the center of curvature running toward the rear of the undertray and of the vehicle.

The wall or flat part 14 has, at the rear, a discontinuity 64 in the form of a corrugation with an “S”-shaped profile separating a front portion 14a of the wall from a rear portion 14b, the latter being angled upward slightly with respect to the front portion.

Furthermore, the wall 14 has a curved depression 76 running from the center to the rear edge of the undertray. The depression in particular intersects the corrugation 64. The depression, which projects from the underside of the wall, makes it possible to leave the space needed to accommodate certain parts of the vehicle exhaust.

The undertray illustrated in the figures is manufactured from four sheets as described in document EP-0 847 912 in the name of the Applicant Company. One of the sheets is used to form the wall 14 while the other three sheets are used to form the auxiliary longitudinal members 16 and the beam 18, respectively.

The sheets are formed by pressing to form these parts. Pressing takes place either in the same press or in different presses. In the latter case, the longitudinal members and the beam are attached to the wall 14 in a subsequent step.

With reference to FIG. 4, the flat part 14 is formed from a stack 1 comprising two skins 3 and an intermediate layer 5 sandwiched between the skins. Each skin 3 comprises a glass-fiber-reinforced thermoplastic. In this particular instance, the skin may be formed by a mixture of polypropylene fibers and of glass fibers, for example from the material known by the trade name TRE. Another possibility consists in forming the skin using a weave of comingled polypropylene fibers and glass fibers, for example the woven known by the trade name Twintex. The intermediate layer 5 will be formed of a cellular structure. This will, for example, be a plastic with a honeycomb structure. The skins will, for example, have a grammage of 500 to 700 g/m² and the intermediate layer will, for example, be 5 mm thick.

The stack formed by these three layers is pressed as a single layer, for example in accordance with the teachings of document EP-0 649 736 in the name of the Applicant Company. During this pressing operation, the cellular structure undergoes local crushing allowing it to be deformed without appreciably harming its overall integrity.

In the case of the longitudinal members 16 and/or the beam 18, these may be formed from a stack comprising the two skins and the intermediate layer as well as at least one additional layer. This layer may, for example, be an additional skin identical to the other two skins. Such a stack will be suitable if the crushing force to be combated is between 20 and 40 kN. The stack may have a thickness of 5 to 10 mm prior to pressing.

In the case of a force of about 40 kN, use may be made of a stack formed of a double sandwich consisting of two lots of the aforementioned sandwich. Thus, from bottom to top, there will be a skin, a cellular layer, two skins, a cellular layer and a skin. This six-layer stack is placed in the compression mold.

In the case of forces of between 40 and 70 kN, the section pieces may be formed of a stack comprising one or more layers of pressable reinforced thermoplastic by giving the entity prior to stacking a thickness of 3 to 8 mm for example. In this particular instance, the stack 9 forming each section piece comprises two skins 11 made of a woven of comingled thermoplastic fibers and glass fibers, between which a layer 13 of pressable reinforced thermoplastic extends.

In the absence of beam 18, there may be either two sets of tooling (one for the flat part and one for the auxiliary longitudinal members), assembly being performed as a rework operation, or there may be one single set of compression tooling with the stack for the flat part at the center and the stacks for the two longitudinal members on the sides, with a high-pressure compression chamber for molding the longitudinal members.

The section pieces may be formed from long-fiber reinforced polypropylene.

They may be made of SMC (Sheet Molding Compound: the molding of prepregs).

In another embodiment, provision may be made for the auxiliary longitudinal members 16 and/or the beam 18 to be produced from the stack 1 comprising the two skins and the cellular intermediate layer, the wall 14 being formed with a stack which has no such cellular layer.

In the embodiment illustrated in FIGS. 1 to 4, the undertray can be fixed at the front to the bottom of the apron of the vehicle and, at the sides, to a cross-tie of the vehicle and, at the rear, to the engine mounting. It is possible to use the undertray as a support for the vehicle cooling pack.

The cellular material may be a foam. The honeycomb structure may be made of polypropylene or poly-carbonate.

Crash testing has demonstrated that the role of the closure wall 14 in the impact was rigid enough to hold the longitudinal members in position. The other functions of the wall 14 are those of a conventional undertray, that is to say of improving the aerodynamics of the vehicle and having an acoustic function while at the same time resisting environmental attack (ability to withstand fluids in the engine environment, resistance to stone chippings).

FIG. 5 illustrates an alternative form of this embodiment. Here, the flat part has a second cavity 78, offcentered the latter.

FIGS. 6 and 7 illustrate a second embodiment of the undertray according to the invention. The undertray consists of the same materials as in the first embodiment and is very similar to that of the first embodiment. The bodywork and chassis of a vehicle including the undertray according to the invention have been partially depicted. The chassis comprises two longitudinal members 2 of a conventional type, running in the direction of travel of the vehicle, for example made of metal.

The bodywork comprises a profiled bumper beam 4 running transversely to the direction of travel, opposite a front end of the longitudinal members 2, from one of the longitudinal members to the other. This beam 4 here is made of a glass-fiber-reinforced thermoplastic. It is produced by molding. The beam has a transverse profile in the shape of a “U” open toward the rear of the vehicle with reference to the main direction of travel of the vehicle. It comprises two protrusions 6 of cylindrical overall shape running rearward from two openings 8 in the front face of the beam. The protrusions 6 are of one piece with the beam. They are designed to be accommodated in the open front ends of the longitudinal members 2 so that the beam can be fixed to these members.

The bodywork comprises an upper impact absorber 10 of profiled shape, made of a deformable cellular material such as a foam. This absorber 10 is mounted in front of the beam 4, parallel to the latter, resting against the front face of the beam. This type of absorber is known per se.

The undertray 12 also has two straight section pieces 20 with trapezoidal profile running at an angle from the center of the front section piece 18 as far as the center of the longitudinal members 16. The sheet has a slot 22 at its rear edge. The undertray has, as its plane of symmetry, the longitudinal vertical mid-plane of the vehicle.

At their rear end, the longitudinal members 16 have a flat buffer 24 in the form of a wall closing off the longitudinal members. These buffers, perpendicular to the direction of travel of the vehicle, rest against similar buffers 26 belonging to the vehicle engine mounting. In this instance, the undertray is fixed by its rear edge to two horizontal lugs 28 formed integrally with the engine mounting, by its lateral edges to two upper lugs 30 formed integrally with the bodywork and known per se, different than the longitudinal members 2 and not directly fixed thereto, and by its front edge to the skin of the bumper as will be seen. This is merely one example of how the undertray is fixed to the vehicle and it is clear that other methods of fixing may be envisioned. As a preference, the undertray will not be connected to the longitudinal members 2, so that an impact on the undertray does not cause these longitudinal members to flex.

The bodywork comprises a lower impact absorber 32 of a profiled shape, made of a deformable cellular material such as a foam. This absorber is mounted in front of the transverse beam 18 of the undertray 12, resting against this beam and against the front edge of the sheet. Here it is bonded to them. As an alternative, it could be welded or clipped to the section piece 18.

The transverse section piece 18 runs more or less vertically underneath the bumper beam 4. Likewise, the lower absorber 32 runs more or less vertically under the upper absorber 10.

The bodywork comprises a profiled bumper skin 34 of a conventional type running past the two absorbers 10, 32, from one of these to the other, covering their front face and concealing them from view from the front of the vehicle. The skin 34 is fixed to each absorber in a conventional way, for example, in the case of the lower absorber 32, by means of bolts 34 which also pass through the wall 14 of the undertray.

This undertray 12 has good stability in an impact at 56 km/h. In an impact with a pedestrian, the section piece 18 acts as a low point of contact at shin level 36, the center of gravity of which is situated at the point 38. The shin is separated from the leg 40 by the knee 42. As a preference, the undertray will be sited low enough down that the impact will usually occur below the center of gravity 38 of the shin so as to make it easier for the leg to start to turn.

If there is a desire to absorb even more energy (more than 20 kg per side), it is possible to add other longitudinal members to the component, for example the longitudinal members 20 of FIG. 6.

It is also possible to give the undertray the shape of a corrugated plate and to create a support along the entire end of the undertray (rear part) so as to absorb energy across the entire width of the undertray in the event of a crash.

Of course, numerous modifications could be made to the invention without departing from its scope.

Thus, as long as at least one section piece has a material different than that of the flat part, it is possible to envision for at least one other section piece to be made of a material identical to that of the flat part and, for example, to extend as one piece therewith. For example, after forming the section piece of one piece with the flat part and at a location contiguous therewith, this section piece could be folded onto the flat part (to close off its “U”-shaped opening) through a hinge effect between the section piece and the flat part.

1. Engine undertray (12) for a vehicle, comprising an essentially flat part (14) and at least one section piece (16, 18), one (14) out of the flat part and the section piece comprising a first material (1) with two layers (3) of reinforced thermoplastic between which an intermediate layer (5) extends, the other (16, 18) out of the flat part and the section piece comprising a second material (9) different than the first material, characterized in that the intermediate layer (5) is a layer of cellular material.

2. Undertray according to claim 1, characterized in that the second material (9) comprises at least one layer of thermoplastic (11, 13).

3. Undertray according to one of claims 1 and 2, characterized in that the flat part (14) comprises the first material (1).

4. Undertray according to one of claims 1 and 2, characterized in that the section piece comprises the first material.

5. Undertray according to one of claims 1 to 4, characterized in that the cellular material (5) has a honeycomb structure.

6. Undertray according to one of claims 1 to 5, characterized in that in the flat part (14), at least one of the layers of thermoplastic (3) comprises thermoplastic fibers and glass fibers.

7. Undertray according to claim 6, characterized in that the thermoplastic fibers and the glass fibers are woven.

8. Undertray according to one of claims 1 to 7, characterized in that the section piece (18) runs transversely with reference to a direction of the component (12) that is intended to correspond to the direction of travel of the vehicle.

9. Undertray according to one of claims 1 to 8, characterized in that it comprises at least two section pieces (16) running parallel to a direction of the component (12) that is intended to correspond to the direction of travel of the vehicle.

10. Undertray according to one of claims 1 to 9, characterized in that the or each section piece (16, 18) comprises a stack of two pairs of layers of thermoplastic and two layers of cellular material, one extending between the layers of each respective pair.

11. Undertray according to one of claims 1 to 10, characterized in that the flat part has corrugations.
